(19) United States
(12) Patent Application Publication
(10) Pub. No.: US 2023/0381714 A1
(43) Pub. Date: Nov. 30, 2023

(54) GAS RECOVERY SYSTEM

(71) Applicant: DENSO CORPORATION, Kariya-city (JP)

(72) Inventors: Shota KINOSHITA, Nisshin-city (JP); Hironori TATSUMI, Kariya-city (JP); Nobuhiko MATSUDA, Kariya-city (JP)

(21) Appl. No.: 18/308,716

(22) Filed: Apr. 28, 2023

(30) Foreign Application Priority Data
May 31, 2022 (JP) 2022-088377

(51) Int. Cl. B01D 53/32

(52) U.S. Cl. CPC B01D 53/326; B01D 2257/504; B01D 2256/22

(57) ABSTRACT

A gas recovery system includes: a working electrode that adsorbs a recovery target gas; a counter electrode that exchanges electrons with the working electrode; a working-electrode current collector in contact with the working electrode to electrically connect the working electrode and the counter electrode; and a counter-electrode current collector in contact with the counter electrode to electrically connect the working electrode and the counter electrode. The working-electrode current collector has a working electrode opening to expose the working electrode to the gas mixture. The counter-electrode current collector has a counter electrode opening to expose the counter electrode to the gas mixture. An opening area of the counter electrode opening is smaller than an opening area of the working electrode opening.

### CROSS REFERENCE TO RELATED APPLICATION

This application is based on Japanese Patent Application No. 2022-088377 filed on May 31, 2022, the disclosure of which is incorporated herein by reference.

### TECHNICAL FIELD

The present disclosure relates to a gas recovery system to recover a recovery target gas from a gas mixture containing the recovery target gas.

### BACKGROUND

A carbon dioxide recovery system recovers carbon dioxide, which is a recovery target gas, from a gas mixture. The carbon dioxide recovery system includes an electrochemical cell that adsorbs carbon dioxide through an electrochemical reaction.

### SUMMARY

A gas recovery system is configured to recover a recovery target gas from a gas mixture by an electrochemical reaction. The gas recovery system includes: a working electrode that adsorbs the recovery target gas; a counter electrode that exchanges electrons with the working electrode; a working-electrode current collector in contact with the working electrode to electrically connect the working electrode and the counter electrode; and a counter-electrode current collector in contact with the counter electrode to electrically connect the working electrode and the counter electrode. The working-electrode current collector has a working electrode opening to expose the working electrode to the gas mixture. The counter-electrode current collector has a counter electrode opening to expose the counter electrode to the gas mixture. An opening area of the counter electrode opening is smaller than an opening area of the working electrode opening.

### BRIEF DESCRIPTION OF DRAWINGS

FIG. 1 is a diagram illustrating an overall configuration of a carbon dioxide recovery system according to a first embodiment;

FIG. 2 is a perspective view of a carbon dioxide recovery device of the first embodiment;

FIG. 3 is a cross-sectional view of an electrochemical cell of the first embodiment;

FIG. 4 is an exploded perspective view of the electrochemical cell of the first embodiment;

FIG. 5A is an explanatory diagram for explaining a method of manufacturing the electrochemical cell of the first embodiment;

FIG. 5B is an explanatory diagram for explaining the method of manufacturing the electrochemical cell of the first embodiment;

FIG. 5C is an explanatory diagram for explaining the method of manufacturing the electrochemical cell of the first embodiment;

FIG. 6 is an exploded perspective view of an electrochemical cell according to a second embodiment;

FIG. 7 is an explanatory diagram for explaining a method of manufacturing the electrochemical cell of the second embodiment;

FIG. 8A is an explanatory diagram for explaining a method of manufacturing an electrochemical cell according to a third embodiment; and

FIG. 8B is an explanatory diagram for explaining the method of manufacturing the electrochemical cell of the third embodiment.

### DETAILED DESCRIPTION

Conventionally, a carbon dioxide recovery system is configured to recover carbon dioxide, which is a recovery target gas, from a gas mixture containing carbon dioxide. The carbon dioxide recovery system includes an electrochemical cell that adsorbs carbon dioxide through an electrochemical reaction.

The electrochemical cell is formed as a stacked body including a working electrode, a counter electrode, a working-electrode current collector, and a counter-electrode current collector, each of which is formed in a flat-plate shape, in the stacked manner. The working electrode includes a carbon dioxide adsorbent that absorbs carbon dioxide from the gas mixture. The counter electrode includes an electroactive auxiliary material that exchanges electrons with the working electrode. The working-electrode current collector is an electrode in contact with the working electrode. The counter-electrode current collector is an electrode in contact with the counter electrode.

In a carbon dioxide recovery system, it is required that the working electrode is exposed to a gas mixture in order to cause the carbon dioxide to be adsorbed on the carbon dioxide adsorbent of the working electrode. In this case, the working-electrode current collector may be formed of a gas permeable film.

However, exposure of the counter electrode to the gas mixture can result in oxidation of the electroactive auxiliary material of the counter electrode. Oxidation of the electroactive auxiliary material reduces the ability of the gas recovery system to recover the gas. However, there is no mention about suppression of oxidation of the electroactive auxiliary material.

The present disclosure provides a gas recovery system capable of suppressing deterioration in the recovery performance of a gas to be recovered.

According to an aspect of the present disclosure, a gas recovery system recovers a recovery target gas from a gas mixture by an electrochemical reaction, and includes a working electrode, a counter electrode, a working-electrode current collector and a counter-electrode current collector.

The working electrode adsorbs the recovery target gas. The counter electrode exchanges electrons with the working electrode. The working-electrode current collector is in contact with the working electrode to electrically connect the working electrode and the counter electrode. The counter-electrode current collector is in contact with the counter electrode to electrically connect the working electrode and the counter electrode.

A working electrode opening for exposing the working electrode to the gas mixture is formed in the working-electrode current collector. A counter electrode opening is formed in the counter-electrode current collector to expose the counter electrode to the gas mixture. The opening area of the counter electrode opening is smaller than the opening area of the working electrode opening.

Accordingly, since the opening area of the counter electrode opening is smaller than the opening area of the working electrode opening, the counter electrode is less likely to be exposed to the gas mixture. Therefore, it is possible to restrict the counter electrode from being oxidized, thereby suppressing deterioration in the ability of the gas recovery system to recover the gas.

According to another aspect of the present disclosure, a gas recovery system recovers a recovery target gas from a gas mixture by an electrochemical reaction, and includes a working electrode, a counter electrode, a working-electrode current collector and a counter-electrode current collector.

The working electrode adsorbs the recovery target gas. The counter electrode exchanges electrons with the working electrode. The working-electrode current collector is in contact with the working electrode to electrically connect the working electrode and the counter electrode. The counter-electrode current collector is in contact with the counter electrode to electrically connect the working electrode and the counter electrode.

The working-electrode current collector has a working electrode opening through which the gas mixture is exposed to the working electrode. The counter-electrode current collector is formed so as to prohibit contact between the gas mixture and the counter electrode.

Accordingly, the counter-electrode current collector is formed so as to prohibit contact between the gas mixture and the counter electrode. Therefore, it is possible to restrict the counter electrode from being oxidized, thereby suppressing deterioration in the ability of the gas recovery system to recover the gas.

It should be noted that the reference numerals described in this specification are examples showing the corresponding relationship with specific means described in the embodiments described later.

Embodiments will be described below with reference to the drawings. In each embodiment, parts corresponding to items described in the preceding embodiment are denoted by the same reference signs, and redundant description may be omitted. In a case where only a part of a configuration is described in each embodiment, the other embodiments described above are capable of being applied for the other parts of the configuration. It is possible not only to combine parts that are explicitly stated, in each embodiment, to be combinable but also to partially combine embodiments that are not explicitly stated to be combinable as long as no problem arises when combined.

### First Embodiment

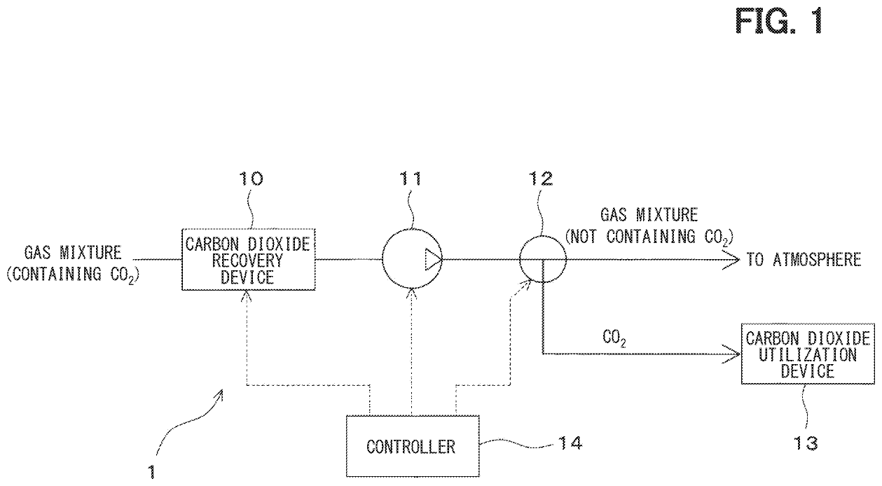

A gas recovery system according to the first embodiment will be described with reference to FIGS. 1 to 5C. In this embodiment, the gas recovery system is applied to a carbon dioxide recovery system 1 that separates and recovers carbon dioxide from a gas mixture containing carbon dioxide. A recovery target gas in the present embodiment is carbon dioxide.

As shown in FIG. 1, the carbon dioxide recovery system 1 includes a carbon dioxide recovery device 10, a pump 11, a flow path switch valve 12, a carbon dioxide utilization device 13, and a controller 14.

The carbon dioxide recovery device 10 separates and recovers carbon dioxide from the gas mixture. The atmospheric air or an exhaust gas of an internal combustion engine can be used for the gas mixture. The gas mixture also contains a gas other than carbon dioxide. The gas mixture is supplied to the carbon dioxide recovery device 10. The carbon dioxide recovery device 10 discharges the gas mixture from which carbon dioxide has been removed, or the recovered carbon dioxide. A detailed configuration of the carbon dioxide recovery device 10 will be described later.

The carbon dioxide recovery device 10 has an outlet port to which a suction port of the pump 11 is connected. The pump 11 sucks the gas mixture from which carbon dioxide has been removed, or the recovered carbon dioxide, from the carbon dioxide recovery device 10. Furthermore, the gas mixture is supplied to the carbon dioxide recovery device 10 by the suction action of the pump 11.

In the present embodiment, the pump 11 is disposed on the downstream side in the gas flow direction of the carbon dioxide recovery device 10. However, the pump 11 may be disposed on the upstream side in the gas flow direction of the carbon dioxide recovery device 10.

The pump 11 has a discharge port to which an inlet side of the flow path switch valve 12 is connected. The flow path switch valve 12 is a three-way valve that switches the flow path for a gas flowing out of the carbon dioxide recovery device 10. The flow path switch valve 12 thus switches between a flow path that allows the gas flowing out of the carbon dioxide recovery device 10 to flow out to the atmosphere side and a flow path that allows the gas flowing out of the carbon dioxide recovery device to flow out toward the carbon dioxide utilization device 13.

The carbon dioxide utilization device 13 utilizes carbon dioxide. For the carbon dioxide utilization device 13, for example, a storage tank that stores carbon dioxide or a conversion device that converts carbon dioxide into fuel can be used. The conversion device converts carbon dioxide into a hydrocarbon fuel such as methane. The hydrocarbon fuel may be a fuel in a gas form at normal temperature and normal pressure, or may be a fuel in a liquid form at normal temperature and normal pressure.

The controller 14 is configured of a well-known microcomputer including a calculation processing device (i.e., CPU), a read only memory (i.e., ROM), a random access memory (i.e., RAM) and the like, and peripheral circuits thereof. The controller 14 performs various calculations and processing on the basis of a control program stored in the ROM, and controls the operations of various control target devices connected to the output side of the controller 14. More specifically, the controller 14 according to the present embodiment controls the operations of the carbon dioxide recovery device 10, the pump 11, and the flow path switch valve 12.

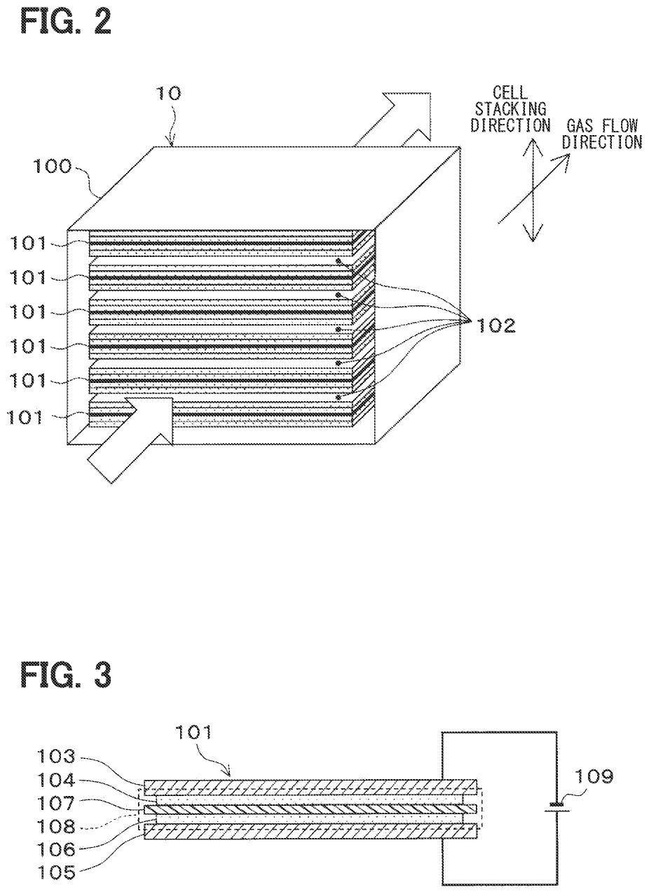

Next, the carbon dioxide recovery device 10 will be described with reference to FIGS. 2 to 5C. As shown in FIG. 2, the carbon dioxide recovery device 10 has a housing 100 and electrochemical cells 101. The housing 100 is formed of a metal material. The housing 100 may be formed of a resin material.

The housing 100 has a gas inflow part and a gas outflow part. The gas inflow part is an opening that allows the gas mixture to flow into the housing 100. The gas outflow part is an opening through which the gas mixture from which carbon dioxide has been removed or the recovered carbon dioxide flows out from the housing 100.

The electrochemical cells 101 cause an electrochemical reaction to adsorb carbon dioxide, and thus separates and recovers the carbon dioxide from the gas mixture. The electrochemical cell 101 causes an electrochemical reaction to desorb the adsorbed carbon dioxide, and thus releases the adsorbed carbon dioxide. The electrochemical cells 101 are housed in the housing 100.

The electrochemical cell 101 is formed in a rectangular flat-plate shape. The electrochemical cells 101 are stacked at a regular interval such that plate surfaces thereof are parallel to one another inside the housing 100. A gas passage 102 is formed between the electrochemical cells 101 adjacent to each other, so as to allow the gas mixture flowing from the gas inflow part to flow therethrough.

Thus, the flow direction of the gas mixture is parallel to the plate surface of the electrochemical cell 101, and is perpendicular to the stacking direction of the electrochemical cells 101.

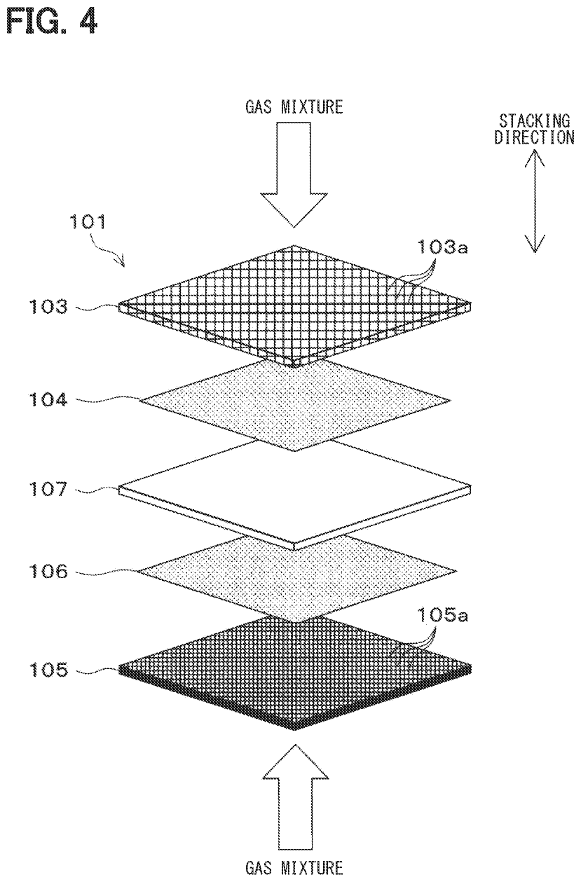

As shown in FIGS. 3 and 4, the electrochemical cell 101 has a working-electrode current collector 103, a working electrode 104, a counter-electrode current collector 105, a counter electrode 106, a separator 107, and an electrolyte layer 108. Each of the working-electrode current collector 103, the working electrode 104, the counter-electrode current collector 105, the counter electrode 106, and the separator 107 is formed in rectangular flat-plate shape.

The electrochemical cell 101 is formed as a stacked body including the working-electrode current collector 103, the working electrode 104, the counter-electrode current collector 105, the counter electrode 106, and the separator 107 stacked on top of one another. A stacking direction in which the working-electrode current collector 103 and the like are stacked in each of the electrochemical cells 101 coincides with a stacking direction of the electrochemical cells 101 stacked inside the housing 100.

The working-electrode current collector 103 is a conductive member that electrically connects the working electrode 104 and the counter electrode 106 by being in contact with the working electrode 104. The working-electrode current collector 103 has one flat surface, which is exposed to the gas mixture. The working-electrode current collector 103 has the other flat surface, which is in contact with the working electrode 104. The working-electrode current collector 103 has a working electrode opening 103a through which the gas mixture on the one flat surface side is exposed to the working electrode 104 on the other flat surface side.

More specifically, the working-electrode current collector 103 of the present embodiment is made of a metal porous body. The working electrode opening 103a according to the present embodiment is formed by causing pores formed inside the working-electrode current collector 103 to communicate with one another. For the working-electrode current collector 103, a porous metal body having a porosity that is equal to or higher than 50% can be used. The porosity is defined as a ratio of the volume of pores to an apparent volume.

The working electrode 104 can adsorb and recover carbon dioxide from the gas mixture, and can desorb and release the recovered carbon dioxide. The working electrode 104 has a carbon dioxide adsorbent, a conductive additive, and a binder. The carbon dioxide adsorbent, the conductive additive, and the binder are used in a state of a mixture. More specifically, in the present embodiment, fine particles of the carbon dioxide adsorbent and fine particles of the conductive additive are used in a state of being held by the binder.

The carbon dioxide adsorbent is an electroactive species that adsorbs carbon dioxide by receiving electrons and desorbs the adsorbed carbon dioxide by releasing electrons. For example, a carbon material, a metal oxide, polyanthraquinone, or the like can be used as the carbon dioxide adsorbent.

The conductive additive forms a conductive path to the carbon dioxide adsorbent. For the conductive additive, for example, a carbon material such as carbon nanotube, carbon black, or graphene can be used.

The binder is a binding material that holds the carbon dioxide adsorbent and the conductive additive. For the binder, for example, a high-molecular polymer conductive resin can be used. As the conductive resin, an organic material such as an epoxy resin containing Ag or the like as a conductive filler, or a fluorine resin such as polytetrafluoroethylene (PTFE) or polyvinylidene fluoride (PVDF) can be used.

The counter-electrode current collector 105 is a conductive member that electrically connects the working electrode 104 and the counter electrode 106 by being in contact with the counter electrode 106. The counter-electrode current collector 105 has one flat surface, which is exposed to the gas mixture. The counter-electrode current collector 105 has the other flat surface, which is in contact with the counter electrode 106. The counter-electrode current collector 105 has a counter electrode opening 105a through which the gas mixture on one flat surface side is exposed to the counter electrode 106 on the other flat surface side.

Specifically, the counter-electrode current collector 105 according to the present embodiment is formed of a porous metal body, similarly to the working-electrode current collector 103. The counter electrode openings 105a is formed by causing plural pores formed inside the counter-electrode current collector 105 to communicate with one another. For the counter-electrode current collector 105, a porous metal body having a porosity that is equal to or lower than 70% is desirably used.

Furthermore, in this embodiment, as the counter-electrode current collector 105, a metal porous body having a smaller porosity than the working-electrode current collector 103 is used. As a result, the opening area of the counter electrode opening 105a of the counter-electrode current collector 105 is smaller than the opening area of the working electrode opening 103a of the working-electrode current collector 103.

Moreover, in this embodiment, plural working electrode openings 103a and plural counter electrode openings 105a are formed. Therefore, the total opening area of the contact surface between the working-electrode current collector 103 and the working electrode 104 can be used as the opening area of the working electrode opening 103a. Similarly, as the opening area of the counter electrode opening 105a, the total opening area of the contact surface between the counter-electrode current collector 105 and the counter electrode 106 can be used.

The counter electrode 106 exchanges electrons with the working electrode 104, when the carbon dioxide adsorbent adsorbs or desorbs carbon dioxide. The counter electrode 106 includes an electroactive auxiliary material, a conductive additive, and a binder. The electroactive auxiliary material, the conductive additive, and the binder are used in a state of a mixture. More specifically, fine particles of the electroactive auxiliary material and fine particles of the conductive additive are used in a state of being held by the binder, in the present embodiment.

The respective basic structures of the conductive additive and the binder of the counter electrode 106 are similar to the respective basic structures of the conductive additive and the binder of the working electrode 104. The electroactive auxiliary material is an auxiliary electroactive species that exchanges electrons with the carbon dioxide adsorbent of the working electrode 104, and is an active material that has an oxidation-reduction property. For the active material, an organic compound having a π bond, a transition metal compound having plural oxidation numbers, or a metal complex capable of exchanging electrons by changing the valence of the metal ion can be used.

Examples of such metal complex include cyclopentadienyl metal complexes such as ferrocene, nickelocene and cobaltocene, and porphyrin metal complexes. Each of these metal complexes may be a polymer or a monomer.

The separator 107 is disposed between the working electrode 104 and the counter electrode 106, and separates the working electrode 104 and the counter electrode 106. The separator 107 is an insulating ion-permeable membrane that enables avoidance of physical contact between the working electrode 104 and the counter electrode 106 to avoid an electrical short circuit, and that allows ions to permeate therethrough. For the separator 107, a cellulose membrane, a polymer, a composite material of a polymer and a ceramic, or the like can be used.

The electrolyte layer 108 is an immersion layer in which the working electrode 104, the separator 107, and the counter electrode 106 are immersed. For the electrolyte layer 108, for example, an ionic liquid can be used. The ionic liquid is a salt of a liquid having non-volatility under normal temperature and pressure.

Further, a power source 109 is connected to the working-electrode current collector 103 and the counter-electrode current collector 105 of the electrochemical cell 101. The power source 109 can change a potential difference between the working electrode 104 and the counter electrode 106 by applying a predetermined voltage to the working electrode 104 and the counter electrode 106. The working electrode 104 is a negative electrode, and the counter electrode 106 is a positive electrode.

The electrochemical cell 101 operates in a carbon dioxide recovery mode and in a carbon dioxide release mode by changing a potential difference between the working electrode 104 and the counter electrode 106. The carbon dioxide recovery mode is a mode in which carbon dioxide is recovered at the working electrode 104. The carbon dioxide release mode is a mode in which carbon dioxide is released from the working electrode 104. The carbon dioxide recovery mode is a charge mode in which the electrochemical cell 101 is charged. The carbon dioxide release mode is a discharge mode in which the electrochemical cell 101 is discharged.

Specifically, in the carbon dioxide recovery mode, a first voltage V1 is applied between the working electrode 104 and the counter electrode 106, and electron donation occurs from the counter electrode 106 to the working electrode 104. At the first voltage V1, the counter electrode potential is greater than the working electrode potential. The first voltage V1 may fall within a range between 0.5 and 2.0 V.

In the carbon dioxide release mode, a second voltage V2 is applied between the working electrode 104 and the counter electrode 106, and electron donation occurs from the working electrode 104 to the counter electrode 106. The second voltage V2 is different from the first voltage V1. The second voltage V2 is lower than the first voltage V1, and a magnitude relationship between the working electrode potential and the counter electrode potential is not limited. That is, in the carbon dioxide release mode, the working electrode potential may be smaller than the counter electrode potential, the working electrode potential may be equal to the counter electrode potential, or the working electrode potential may be larger than the counter electrode potential.

Next, a method for manufacturing the electrochemical cell 101 will be described. The manufacturing method of the electrochemical cell 101 of the present embodiment has a working-electrode current collector attaching step of attaching the working electrode 104 to the working-electrode current collector 103, and a counter-electrode current collector attaching step of attaching the counter electrode 106 to the counter-electrode current collector 105. The step of attaching the current collector to the working electrode and the step of attaching the current collector to the counter electrode can be carried out separately.

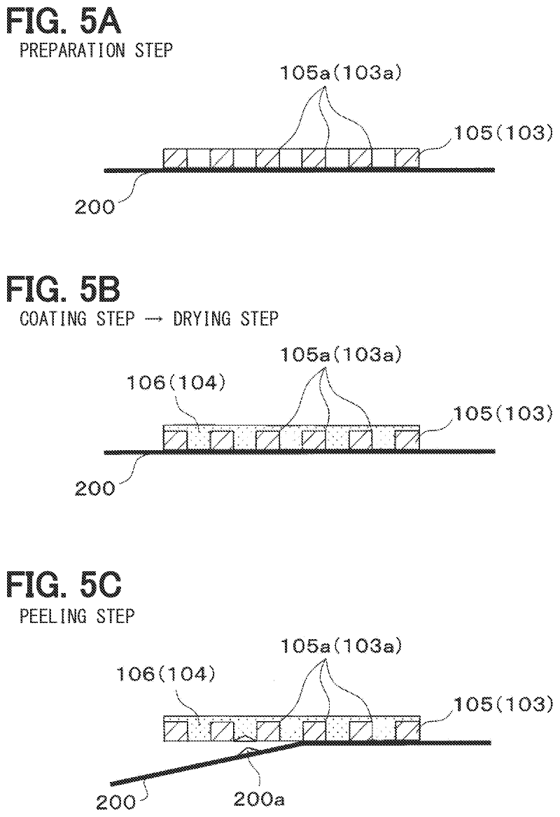

The step of attaching the current collector to the working electrode and the step of attaching the current collector to the counter electrode are basically the same. Therefore, in FIGS. 5A to 5C, the step of attaching the current collector on the counter electrode will be described. Furthermore, in FIGS. 5A to 5C, the reference numeral of each component in the step of attaching the current collector on the working electrode is shown in parentheses.

As shown in FIGS. 5A to 5C, in the step of attaching the current collector on the counter electrode, a preparation step, a coating step, a drying step, and a peeling step are performed. In the preparation step, the counter-electrode current collector 105 is arranged on the release paper 200 arranged on the plane. The release paper 200 is a release liner used in the molding process of a substance exhibiting temporary adhesion.

In the coating step, a paste-like counter electrode 106 is screen-printed on the upper surface of the counter-electrode current collector 105 after the preparatory step, that is, on the opposite surface of the release paper 200, by mixing an electroactive auxiliary material, a conductive additive, and a binder. As a result, the paste-like counter electrode 106 is applied to not only the upper surface of the counter-electrode current collector 105 but also the inside of the counter electrode opening 105a.

In the drying step, the counter electrode 106 applied to the counter-electrode current collector 105 after the coating step is dried. Thereby, the counter electrode 106 is cured. Accordingly, the counter electrode 106 is formed by compacting fine particles of the electroactive auxiliary material and fine particles of the conductive additive together with the binder. In the drying step, the counter-electrode current collector 105 and the counter electrode 106 may be heated in order to increase the drying speed. Also, the counter-electrode current collector 105 and the counter electrode 106 may be placed under a low-pressure environment.

In the peeling step, the release paper 200 is peeled off from the counter-electrode current collector 105. In the peeling process, as shown in FIG. 5C, a part of the counter electrode 106 may be peeled off together with the release paper 200 as a residual portion 200a. The residual portion 200a causes a defect in the counter electrode 106. Therefore, in the peeling step, it is desirable to peel off the release paper 200 so as not to form defects in the counter electrode 106.

Through the above steps, the counter electrode 106 is adhered to the counter-electrode current collector 105 in the step of attaching the current collector on the counter electrode. In the step of attaching the working electrode 104 to the working-electrode current collector 103, the same preparation step, coating step, drying step, and peeling step are performed.

Then, a bonding step is performed, while the separator 107 is interposed between the working electrode 104 and the counter electrode 106, to bond the counter-electrode current collector 105 and the counter electrode 106 and to bond the working-electrode current collector 103 and the working electrode 104. As is clear in FIGS. 3 and 4, in the bonding step, the surface of the counter electrode 106 and the surface of the working electrode 104 are in contact with the separator 107.

After that, the power source 109 is connected to the working-electrode current collector 103 and the counter-electrode current collector 105. As a result, the electrochemical cell 101 is manufactured.

Next, an operation of the carbon dioxide recovery system 1 of the present embodiment will be described. As described above, the carbon dioxide recovery system 1 operates by alternately switching between the carbon dioxide recovery mode and the carbon dioxide release mode. The operation of the carbon dioxide recovery system 1 is controlled by the controller 14.

First, the carbon dioxide recovery mode will be explained. In the carbon dioxide recovery mode, the pump 11 is operated. As a result, the gas mixture is supplied to the carbon dioxide recovery device 10. In the carbon dioxide recovery device 10, the voltage applied between the working electrode 104 and the counter electrode 106 of the electrochemical cell 101 is the first voltage V1. As a result, electron donation at the electroactive auxiliary material of the counter electrode 106 and electron attraction at the carbon dioxide adsorbent of the working electrode 104 are simultaneously achieved.

The carbon dioxide adsorbent of the working electrode 104 that has received electrons from the counter electrode 106 increases its binding force for carbon dioxide, and binds and adsorbs carbon dioxide contained in the gas mixture. The carbon dioxide recovery device 10 can thus recover carbon dioxide from the gas mixture. The gas mixture from which carbon dioxide has been removed is discharged from the carbon dioxide recovery device 10.

In the carbon dioxide recovery mode, the flow path switch valve 12 switches the flow path to allow the gas mixture discharged from the carbon dioxide recovery device 10 to flow out to the atmosphere side. As a result, the gas mixture discharged from the carbon dioxide recovery device 10 is discharged to the atmosphere.

Next, the carbon dioxide release mode will be described. In the carbon dioxide release mode, the pump 11 is stopped. As a result, the supply of the gas mixture to the carbon dioxide recovery device 10 is stopped. In the carbon dioxide recovery device 10, the voltage applied between the working electrode 104 and the counter electrode 106 of the electrochemical cell 101 is the second voltage V2. As a result, electron donation at the carbon dioxide adsorbent of the working electrode 104 and electron attraction at the electroactive auxiliary material of the counter electrode 106 are simultaneously achieved.

The carbon dioxide adsorbent of the working electrode 104 releases electrons to be in an oxidation state. The carbon dioxide adsorbent decreases its binding force for carbon dioxide, and desorbs and releases carbon dioxide. The carbon dioxide released from the carbon dioxide adsorbent is discharged from the carbon dioxide recovery device 10.

In the carbon dioxide release mode, the flow path switch valve 12 switches the flow path to allow the carbon dioxide discharged from the carbon dioxide recovery device 10 to flow out to an inlet port of the carbon dioxide utilization device 13. As a result, the carbon dioxide discharged from the carbon dioxide recovery device 10 is supplied to the carbon dioxide utilization device 13.

As described above, according to the carbon dioxide recovery system 1 in the present embodiment, carbon dioxide can be recovered from the gas mixture, and the recovered carbon dioxide can be effectively used.

In the electrochemical cell 101 of this embodiment, the counter-electrode current collector 105 has the counter electrode opening 105a. Therefore, the counter electrode 106 is exposed to the gas mixture through the counter electrode opening 105a. At this time, if the gas mixture contains oxygen, the oxygen in contact with the counter electrode 106 receives electrical energy, thereby generating active oxygen species such as superoxide.

Such active oxygen species easily oxidize the electroactive auxiliary material and the binder of the counter electrode 106 made of an organic material. If the electroactive auxiliary material is oxidized, the ability of the electroactive auxiliary material to transfer electrons is reduced. In addition, if the binder is oxidized, the electroactive auxiliary material cannot be retained. As a result, the ability of the working electrode 104 to collect carbon dioxide may decrease.

In contrast, in the electrochemical cell 101 of the present embodiment, the opening area of the counter electrode opening 105a of the counter-electrode current collector 105 is smaller than the opening area of the working electrode opening 103a of the working-electrode current collector 103. Therefore, the counter electrode 106 is less likely to be exposed to the gas mixture. Therefore, it is possible to suppress the oxidation of the electroactive auxiliary material and the binder of the counter electrode 106, thereby suppressing the deterioration in the recovery performance of the recovery target gas in the carbon dioxide recovery system 1.

### Second Embodiment

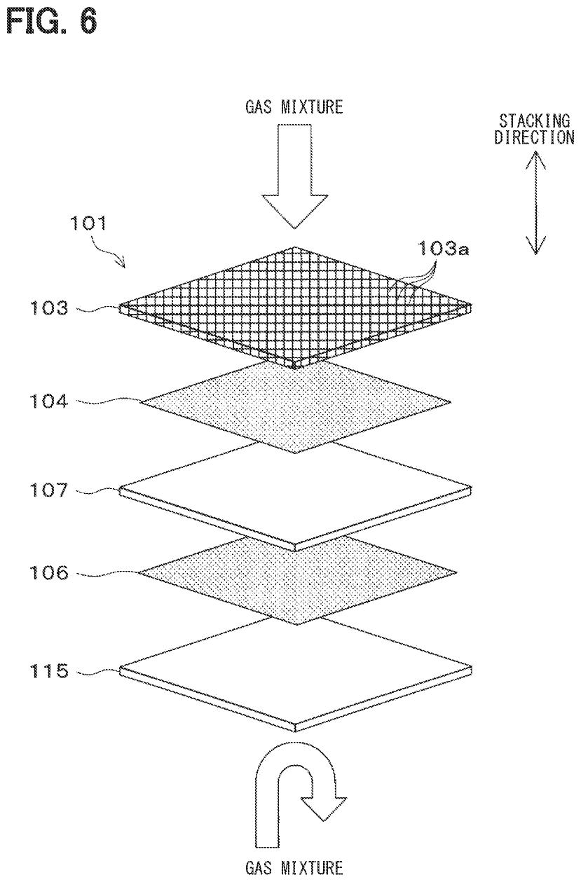

In this embodiment, as shown in FIG. 6, the configuration of the electrochemical cell 101 is changed from the first embodiment. Specifically, in this embodiment, a metal plate is used as the counter-electrode current collector 115. The counter-electrode current collector 115 does not have a structure corresponding to the counter electrode opening 105a described in the first embodiment.

Therefore, the counter-electrode current collector 115 is formed so as to prohibit contact between the gas mixture and the counter electrode 106. In other words, the counter-electrode current collector 115 is formed of a conductive plate-like member without openings, thereby prohibiting contact between the gas mixture and the counter electrode 106.

Furthermore, in the present embodiment, the counter-electrode current collector 115 is made of a metal plate, and the surface roughness Rzo of the counter-electrode current collector 115 opposing the counter electrode 106 is larger than or equal to the average particle diameter φDo of the fine particles of the electroactive auxiliary material 106a and the fine particles of the conductive additive 106b of the counter electrode 106.

The surface roughness Rzo represents a distance from the highest peak to the lowest valley (that is, the height dimension) in an extracted portion by extracting only a reference length from a roughness curve in a predetermined direction. The roughness curve is a curve obtained by removing wavelength components having a predetermined length or more from a cross-sectional polar line drawn by a cross-section perpendicular to a flat surface.

As the surface roughness Rzo, an average distance (for example, ten-point average roughness) obtained by summing the average value of the altitudes of peaks and the average value of the altitudes of valleys may be employed. A so-called arithmetic mean roughness may be employed as the surface roughness Rzo.

The surface roughness Rzo of the counter-electrode current collector 115 is adjusted to a desired value by shot blasting, laser processing, mechanical processing using a grinder or sander, etching, creasing, or the like.

As the average particle diameter φDo of the fine particles of the electroactive auxiliary material 106a and the fine particles of the conductive additive 106b, the value of the electroactive auxiliary material 106a or the conductive additive 106b, whichever has the larger average particle size, may be adopted. Further, an average value of all the particle sizes of the fine particles of the electroactive auxiliary material 106a and the fine particles of the conductive additive 106b may be employed. Other configurations and operations of the electrochemical cell 101 and the carbon dioxide recovery system 1 are the same as in the first embodiment.

Next, a method for manufacturing the electrochemical cell 101 of this embodiment will be described. The step of attaching the current collector on the counter electrode of the present embodiment includes a coating step and a drying step.

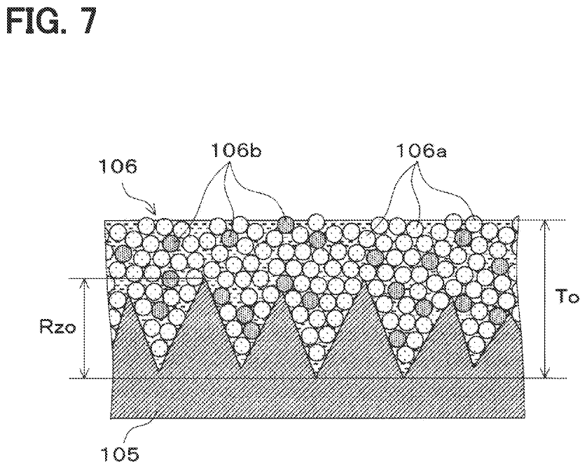

In the coating step of the present embodiment, the paste-like counter electrode 106 is applied to the upper surface of the counter-electrode current collector 115 by screen printing or the like, as in the first embodiment. In the coating process of this embodiment, as shown in FIG. 7, after the drying step, the counter electrode 106 is coated such that the thickness T_{O} of the counter electrode 106 in the stacking direction is greater than the surface roughness Rzo. The thickness T_{O} of the counter electrode 106 is defined as the distance from the lowest valley bottom of the counter-electrode current collector 115 to the outer surface of the counter electrode 106.

In the drying step, as in the first embodiment, the counter electrode 106 applied to the counter-electrode current collector 115 is dried and cured. The counter electrode 106 is adhered to the counter-electrode current collector 115 by the above steps. Other manufacturing methods of the electrochemical cell 101 are the same as those of the first embodiment.

Therefore, according to the carbon dioxide recovery system 1 of this embodiment, it is possible to recover carbon dioxide from the gas mixture by operating in the same manner as in the first embodiment. Then, the recovered carbon dioxide can be effectively used.

Furthermore, in the electrochemical cell 101 of the present embodiment, contact between the gas mixture and the counter electrode 106 is prohibited by the metal plate as the counter-electrode current collector 115. Therefore, the counter electrode 106 is not exposed to oxygen and is not oxidized. As a result, it is possible to suppress a decrease in the ability of the carbon dioxide recovery system 1 to recover the gas.

When a metal plate is employed as the counter-electrode current collector 115 as in the present embodiment, the pasty counter electrode 106 cannot enter the counter electrode opening 105a during the coating step, as in the first embodiment. As a result, the contact area between the counter-electrode current collector 105 and the counter electrode 106 is reduced, so that the counter electrode 106 may be peeled off from the counter-electrode current collector 115.

In contrast, in the electrochemical cell 101 of the present embodiment, as shown in FIG. 7, the counter-electrode current collector 115 is made of a metal plate having the surface roughness Rzo on the surface opposing the counter electrode 106, and the surface roughness Rzo is more than or equal to the average particle diameter φDo of the particles of the electroactive auxiliary material 106a and the conductive additive 106b. Accordingly, the adhesiveness between the counter-electrode current collector 115 and the counter electrode 106 can be improved by the anchor effect.

Meanwhile, if the surface roughness Rzo of the counter-electrode current collector 115 is excessively large, the separator 107 may be damaged and the counter electrode 106 and the working electrode 104 may be short-circuited. In contrast, according to the electrochemical cell 101 of the present embodiment, as shown in FIG. 7, the thickness T_{O} of the counter electrode 106 is larger than the surface roughness Rzo. Therefore, it is possible to suppress the damage of the separator 107 by the counter-electrode current collector 115.

In addition, the step of attaching the current collector on the counter electrode of the electrochemical cell 101 of the present embodiment does not require the peeling step described in the first embodiment. As a result, it is possible to restrict defects from being formed in the counter electrode 106 during the manufacturing process. Thereby, the productivity of the electrochemical cell 101 can be improved.

### Third Embodiment

The basic configuration of the carbon dioxide recovery system 1 of this embodiment is the same as that of the second embodiment. In this embodiment, the manufacturing method of the electrochemical cell 101 is changed from the second embodiment.

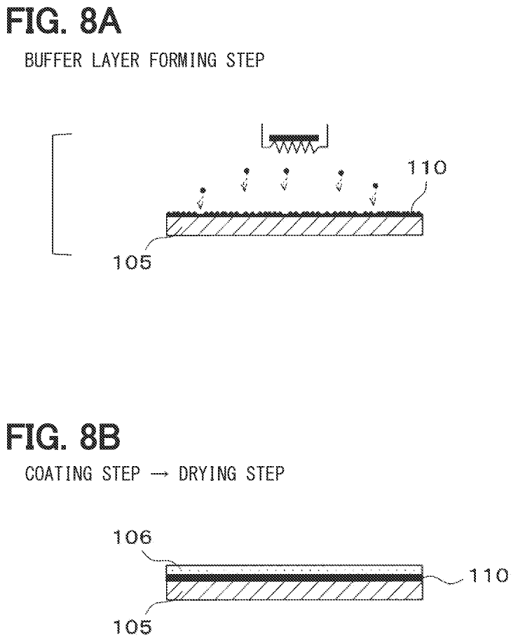

As shown in FIGS. 8A and 8B, in the step of attaching the current collector on the counter electrode of the present embodiment, a buffer layer forming step, a coating step, and a drying step are performed. In the buffer layer forming step, a buffer layer is formed on the surface of the counter-electrode current collector 115. In this embodiment, the buffer layer 110 made of carbon is formed by vacuum deposition.

In the coating step, the paste-like counter electrode 106 is applied to the surface of the counter-electrode current collector 115 on which the buffer layer 110 is formed by screen printing or the like, as in the first embodiment. In the drying step, as in the first embodiment, the counter electrode 106 applied to the counter-electrode current collector 115 is dried. The counter electrode 106 is adhered to the counter-electrode current collector 115 by the above steps. Other manufacturing methods of the electrochemical cell 101 are the same as those of the first embodiment.

Therefore, according to the carbon dioxide recovery system 1 of this embodiment, it is possible to recover carbon dioxide from the gas mixture by operating in the same manner as in the first embodiment. Then, the recovered carbon dioxide can be effectively used. Furthermore, as in the second embodiment, it is possible to inhibit the gas mixture from coming into contact with the counter electrode 106, thereby suppressing a decrease in the ability of the carbon dioxide recovery system 1 to recover the target gas.

Further, in the electrochemical cell 101 of this embodiment, the buffer layer 110 made of carbon is formed between the counter-electrode current collector 115 and the counter electrode 106. Thereby, the adhesion between the counter-electrode current collector 115 and the counter electrode 106 can be improved.

More specifically, carbon adheres well to the metallic counter-electrode current collector 115 by making it finer by vacuum deposition or the like. In addition, since the binder of the counter electrode 106 contains an organic polymer, it has a high affinity for the carbon buffer layer 110. Therefore, in the electrochemical cell 101 of the present embodiment, the adhesion between the counter-electrode current collector 115 and the counter electrode 106 can be improved by forming the buffer layer 110.

### Other Embodiments

The present disclosure is not limited to the embodiment, but may be modified in various ways as hereinbelow without departing from the gist of the present disclosure. The means disclosed in the individual embodiments may be appropriately combined within a feasible range.

In the above embodiment, the gas recovery system is applied to the carbon dioxide recovery system 1 that recovers carbon dioxide from a gas mixture, but application of the gas recovery system is not limited to this. The gas recovery system may be applied to a system for recovering a specific type of gas other than carbon dioxide from gas mixture.

In the first embodiment, the working-electrode current collector 103 and the counter-electrode current collector 105 are made of a metal porous body, but are not limited to this. For example, the working-electrode current collector 103 and the counter-electrode current collector 105 may be made of expanded metal, punching metal, carbon fiber, carbon nonwoven fabric, and conductive polymer film.

The expanded metal, punching metal, or the like has a flat portion. When an expanded metal, a punching metal, or the like is used as the counter-electrode current collector 105, as in the second embodiment, it is desirable that the surface roughness Rzo of the flat portion is set larger than or equal to the average particle diameter of φDo of the particles of the electroactive auxiliary material 106a and the conductive additive 106b. Similarly, it is desirable to make the thickness T_{O} of the counter electrode 106 larger than the surface roughness Rzo of the flat portion.

Moreover, in the second and third embodiments, the counter-electrode current collector 115 is formed of a metal plate, but is not limited to this. For example, as the counter-electrode current collector 115, a current collector having a surface coated with a metal foil, a metal oxide, and a conductive substance may be adopted, while not having a structure corresponding to the counter electrode opening 105a described in the first embodiment.

In the buffer layer forming step of the third embodiment, the carbon buffer layer 110 is formed on the surface of the counter-electrode current collector 115 by vacuum deposition, but is not limited to this. In the buffer layer forming step, the buffer layer 110 may be formed by sputtering.

What is claimed is:

1. A gas recovery system configured to recover a recovery target gas from a gas mixture by an electrochemical reaction, the gas recovery system comprising:
a working electrode that adsorbs the recovery target gas;
a counter electrode that exchanges electrons with the working electrode;
a working-electrode current collector in contact with the working electrode to electrically connect the working electrode and the counter electrode;
a counter-electrode current collector in contact with the counter electrode to electrically connect the working electrode and the counter electrode;
the working-electrode current collector has a working electrode opening to expose the working electrode to the gas mixture,
the counter-electrode current collector has a counter electrode opening to expose the counter electrode to the gas mixture, and
an opening area of the counter electrode opening is smaller than an opening area of the working electrode opening.

2. A gas recovery system configured to recover a recovery target gas from a gas mixture by an electrochemical reaction, the gas recovery system comprising:
a working electrode that adsorbs the recovery target gas;
a counter electrode that exchanges electrons with the working electrode;
a working-electrode current collector in contact with the working electrode to electrically connect the working electrode and the counter electrode;
a counter-electrode current collector in contact with the counter electrode to electrically connect the working electrode and the counter electrode;
the working-electrode current collector has a working electrode opening to expose the working electrode to the gas mixture, and
the counter-electrode current collector is formed to prohibit contact between the gas mixture and the counter electrode.

3. The gas recovery system according to claim 2, wherein
the counter electrode is formed of a plurality of fine particles, and
a surface roughness of a surface of the counter-electrode current collector adjacent to the counter electrode is equal to or greater than an average particle diameter of the fine particles.

4. The gas recovery system according to claim 2, wherein a surface roughness of a surface of the counter-electrode current collector adjacent to the counter electrode is equal to or less than a thickness dimension of the counter electrode.

5. The gas recovery system according to claim 2, wherein a buffer layer is formed between the counter-electrode current collector and the counter electrode to improve adhesion between the counter-electrode current collector and the counter electrode.
